(19) United States
(12) Patent Application Publication
(10) Pub. No.: US 2019/0332034 A1
(43) Pub. Date: Oct. 31, 2019

(54) DEVELOPING APPARATUS AND IMAGE FORMING APPARATUS

(71) Applicant: KONICA MINOLTA, INC., Tokyo (JP)

(72) Inventors: Kei OKAMURA, Yokohama-shi (JP); Hiroyuki SAITO, Itabashi-ku (JP); Shunichi TAKAYA, Hino-shi (JP); Kazuteru ISHIZUKA, Saitama-shi (JP); Aiko KUBOTA, Hino-shi (JP)

(21) Appl. No.: 16/376,308

(22) Filed: Apr. 5, 2019

(30) Foreign Application Priority Data
Apr. 27, 2018 (JP) 2018-086852

(51) Int. Cl. G03G 15/08

(52) U.S. Cl. CPC G03G 15/0889; G03G 15/0815

(57) ABSTRACT

A developing apparatus includes: a developer carrying body that carries a developer and is rotationally driven; a developer stirring member that is rotationally driven and thereby stirs the developer and conveys the developer to the developer carrying body; and a developer recovery member that is rotationally driven and thereby returns and recovers the developer stripped from the developer carrying body after development of the electrostatic latent image, to the developer stirring member, wherein a driving speed of the developer stirring member and a driving speed of the developer recovery member are independently controllable from each other.

The entire disclosure of Japanese patent Application No. 2018-086852, filed on Apr. 27, 2018, is incorporated herein by reference in its entirety.

### BACKGROUND

### Technological Field

The present invention relates to a developing apparatus and an image forming apparatus.

### Description of the Related art

A developing apparatus of an image forming apparatus using an electrophotographic process uses a two-component developer formed with a toner and a carrier, and generally includes a rotationally driven circulatory system screw, a developing roller, and a recovery screw (refer to JP 2002-148921 A, JP 2009-92911 A, and JP 2015-158536A).

The circulatory system screw is a developer stirring member that stirs the developer and supplies (conveys) the stirred developer to the developing roller. The developing roller is a developer carrying body that uses the supplied developer and thereby develops an electrostatic latent image formed on a photoconductive drum. The recovery screw is a developer recovery member that recovers the developer stripped from the developing roller after developing the electrostatic latent image and that returns the developer to the stirring screw.

However, the driving speed of the circulatory system screw is same as the driving speed of the recovery screw, leading to a problem when there is a change in a speed relationship between the developing roller and the circulatory system screw.

For example, in a case where the driving speed of the developing roller is increased under the condition that the driving speeds of the circulatory system screw and the recovery screw are constant, the amount of the developer transferred from the developing roller to the recovery screw exceeds the amount of the developer returned from the recovery screw to the circulatory system. This causes the developer to stagnate in a developer reservoir relevant to the recovery screw, and also causes a reduction in the developer liquid level in the developer reservoir relevant to the circulatory system screw.

The stagnation of the developer increases the pressure of the developing device, and this might be a damage to a developing device. In addition, the reduction of the liquid level of the developer would also cause insufficient supply of developer to the developing roller and erroneous detection by a toner concentration sensor.

### SUMMARY

The present invention has been made to solve the problems associated with the above-described background technology, and aims to provide a developing apparatus and an image forming apparatus capable of suppressing stagnation of a developer in the developer reservoir relevant to a developer recovery member and suppress fluctuation of the liquid level of the developer in the developer reservoir relevant to a developer stirring member even when there is a change in a speed relationship between the developer carrying body and the developer stirring member.

To achieve the abovementioned object, according to an aspect of the present invention, a developing apparatus reflecting one aspect of the present invention comprises: a developer carrying body that carries a developer and is rotationally driven; a developer stirring member that is rotationally driven and thereby stirs the developer and conveys the developer to the developer carrying body; and a developer recovery member that is rotationally driven and thereby returns and recovers the developer stripped from the developer carrying body after development of the electrostatic latent image, to the developer stirring member, wherein a driving speed of the developer stirring member and a driving speed of the developer recovery member are independently controllable from each other.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic view illustrating an image forming apparatus according to an embodiment of the present invention;

FIG. 2 is a cross-sectional view illustrating a developing apparatus illustrated in FIG. 1;

FIG. 3 is a conceptual view illustrating a first developing roller, a second developing roller and a recovery roller illustrated in FIG. 2;

FIG. 4 is a schematic view illustrating a circulatory system screw;

FIG. 5 is a cross-sectional view illustrating a developer discharger illustrated in FIG. 4;

FIG. 6 is a block diagram illustrating a first motor for driving the first developing roller, the second developing roller, the recovery roller and a recovery screw, and a second motor for driving the circulatory system screw;

FIG. 7 is a cross-sectional view illustrating a developer liquid level in a standard state;

FIG. 8 is a cross-sectional view illustrating a developer liquid level in a case where the driving speeds of the first and second developing rollers are increased;

FIG. 9 is a cross-sectional view illustrating a developer liquid level in a case where the developer discharge is excessive;

FIG. 10 is a cross-sectional view illustrating a developing apparatus according to a comparative example;

FIG. 11 is a cross-sectional view illustrating a developer liquid level in a case where the driving speeds of the first and second developing rollers are increased in the comparative example;

FIG. 12 is a cross-sectional view illustrating a developer liquid level in a case where the developer discharge is excessive in the comparative example;

FIG. 13 is a schematic view illustrating a first modification of an embodiment of the present invention; and

FIG. 14 is a schematic view illustrating a second modification of an embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments. Note that, for the purpose of explanation, proportions of dimensions in the drawings might be expanded and might differ from the proportions in reality in some cases.

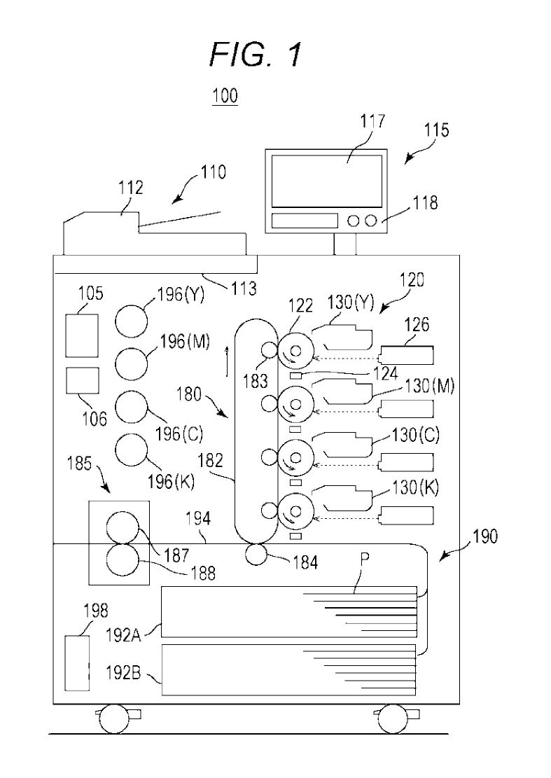

FIG. 1 is a schematic view illustrating an image forming apparatus according to an embodiment of the present invention.

An image forming apparatus 100 is, a multi-function peripheral (MFP) including a copy function, a printer function, and a scan function, for example. As illustrated in FIG. 1, the image forming apparatus 100 includes a controller 105, a storage 106, an image reader 110, an operation display unit 115, an image forming unit 120, a transfer unit 180, a fixing unit 185, a sheet conveyance unit 190, a developer reservoir 196, and a communication interface 198.

The controller 105 is a control circuit including a microprocessor (central processing unit (CPU)), an application specific integrated circuit (ASIC) or the like for executing control of each of the above portions and various types of arithmetic processing in accordance with a program. Executing programs corresponding to individual functions of the image forming apparatus 100 by the controller 105 allows these functions to be implemented.

The storage 106 has a configuration appropriately combining a read only memory (ROM), a random access memory (RAM), and a hard disk drive (HDD), for example. The ROM is a read-only storage device for storing various programs and various data. The RAM is a high-speed random access storage device that temporarily stores programs and data as a work region. The HDD is a large-capacity random access storage device that stores various programs and various data.

The image reader 110 is used to generate image data of a document, and includes an auto document feeder (ADF) 112 and a scanner unit 113. The ADF 112 is used for conveying the mounted documents one by one to a reading position of the scanner unit 113. The scanner unit 113 includes a line image sensor, for example, and generates (photoelectrically converts) image signals on a document conveyed to a reading position by the ADF 112 or on a document mounted on a platen table. The generated electric signal undergoes image processing and then is input to the image forming unit 120. The image processing includes A/D conversion, shading correction, filter processing, and image compression processing. It is also possible to omit the ADF 112 as necessary.

The operation display unit 115 includes a touch screen 117 and a physical keyboard unit 118, for example. The touch screen 117 is used to inform the user of the device configuration, progress status of print jobs, the setting that can be changed at present, or the like. The physical keyboard unit 118 includes a plurality of keys such as a selection key for designating the size of sheet P, a numeric key for setting the number of sheets to copy or the like, a start key for instructing the start of operation, a stop key for instructing to stop the operation. The physical keyboard unit 118 is used by a user to execute text input, various settings, and instruction of start, or the like.

The image forming unit 120 is provided in plurality so as to form an image on the sheet P. Each of the image forming units 120 corresponds to each of colors of yellow (Y), magenta (M), cyan (C), and black (K). Each of the image forming units 120 includes a photoconductive drum 122, a charger 124, an optical writer 126, and a developing apparatus 130.

The photoconductive drum 122 is an image carrying body having a photoconductive layer formed of a resin such as polycarbonate including an organic photoconductor (OPC), and configured to rotate at a predetermined speed. The charger 124 is formed with a corona discharging electrode disposed around the photoconductive drum 122, and charges the surface of the photoconductive drum 122 with generated ions. The optical writer 126 incorporates a scanning optical device, exposes the charged photoconductive drum 122 on the basis of raster image data, thereby reduces the potential of an exposed portion and forms a charge pattern (electrostatic latent image) corresponding to the image data.

The developing apparatus 130 transfers contained developer to the photoconductive drum 122, and develops an electrostatic latent image formed on the photoconductive drum 122. The developer is a mixture of a carrier and a toner corresponding to individual colors. The electrostatic latent image is visualized by the toner.

The transfer unit 180 includes an intermediate transfer belt 182, a primary transfer roller 183, and a secondary transfer roller 184. The intermediate transfer belt 182 is wound on the primary transfer roller 183 and a plurality of other rollers so as to be movably supported by the rollers. The primary transfer roller 183 is provided in plurality corresponding to each of colors of yellow (Y), magenta (M), cyan (C), and black (K). The secondary transfer roller 184 is disposed outside the intermediate transfer belt 182 so as to allow the sheet P to pass between the intermediate transfer belt 182 and the secondary transfer roller 184.

Toner images of the individual colors formed in the image forming units 120 are sequentially transferred onto the intermediate transfer belt 182 by the primary transfer roller 183, resulting in formation of a toner image of individual colors of yellow, magenta, cyan, and black superimposed with each other. The formed toner image is transferred to the sheet P conveyed by the secondary transfer roller 184.

The fixing unit 185 fixes a color image transferred to the sheet P, and includes a fixing roller (heating roller) 187 and a pressure roller 188. When the sheet P passes between the fixing roller 187 and the pressure roller 188 (nip portion), pressure and heat are applied to the sheet P. This heat melts the toner, thereby fixing a color image on the sheet P.

The sheet conveyance unit 190 includes a plurality of sheet feeding trays 192A and 192B and a sheet conveyance path 194. The sheet feeding trays 192A and 192B accommodates a plurality of stacked sheets P, and the uppermost sheet P is supplied toward the sheet conveyance path 194. The sheet conveyance path 194 includes a plurality of pairs of rollers and a driving motor (not illustrated), and transfers the sheet P from the sheet feeding trays 192A and 192B through the transfer position of the secondary transfer roller 184 and through a nip portion between the fixing roller 187 and the pressure roller 188, and then discharged to the outside of the apparatus. The sheet conveyance unit 190 can also include a sheet reversing unit for discharging the sheet P after reversing the front and back sides of the sheet P, or for forming images on both sides of the sheet P.

The developer reservoir 196 is provided in plural, each corresponding to the developing apparatus 130. The developer reservoirs 196 include bottles each containing developer corresponding to individual colors of color of yellow (Y), magenta (M), cyan (C), and black (K), in a replaceable manner. The developer reservoir 196 is configured to be capable of conveying (replenishing) the developer to the developing apparatus 130 corresponding to the color of the developer reserved.

For example, the toner weight ratio of the developer contained in the bottle is 80% to 95%, while the toner weight ratio of the developer in the developing apparatus 130 is 5% to 10%. Therefore, when the toner is consumed by development in the developing apparatus 130, the developer containing the toner corresponding to the consumption amount is replenished, thereby maintaining the toner weight ratio of the developer in the developing apparatus 130 to a constant level.

The communication interface 198 is an expansion device (LAN board) for providing the image forming apparatus 100 with an additional communication function for connecting to a computer that transmits data such as a print job via a network. The network includes various networks such as a local area network (LAN), a wide area network (WAN) connecting LANs with dedicated lines, the Internet, or a combination of these.

Next, the developing apparatus 130 will be described in detail.

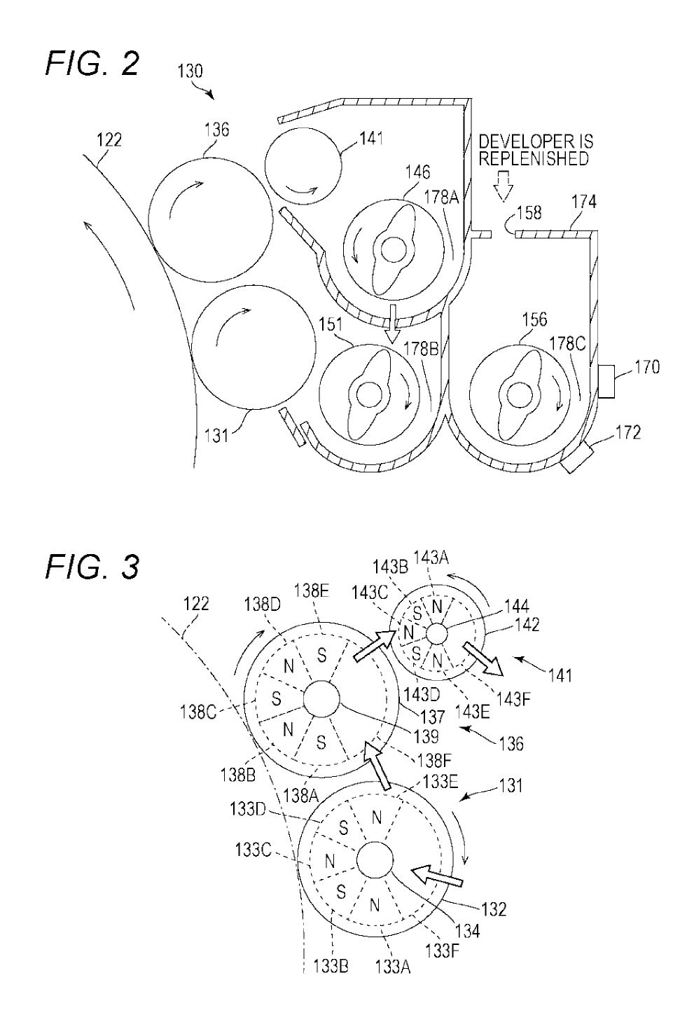

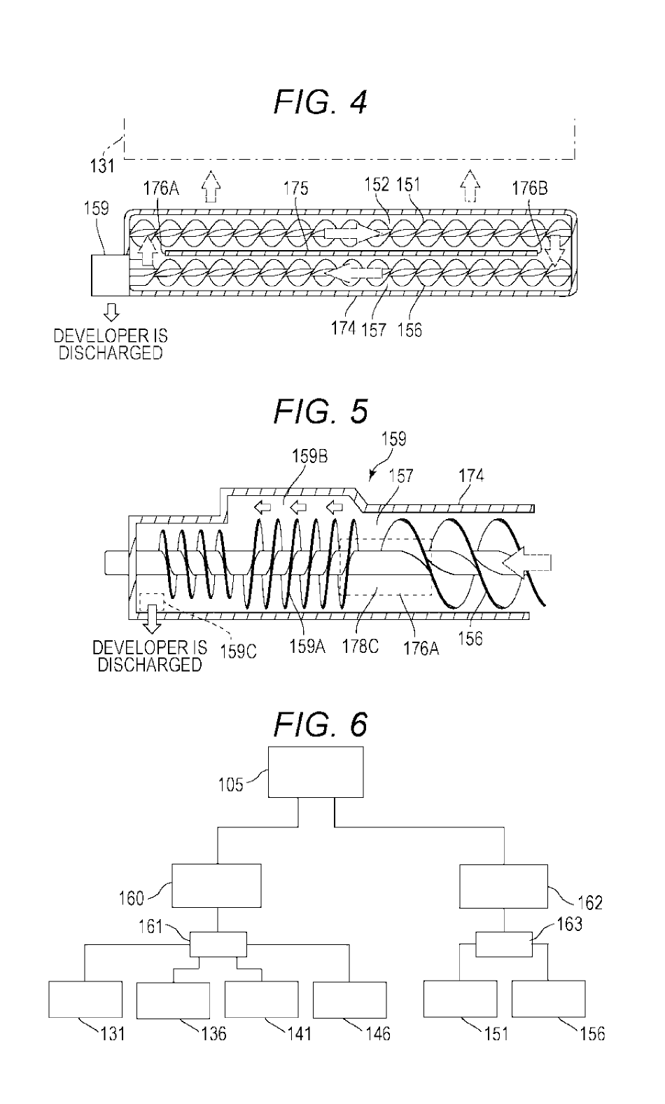

FIG. 2 is a cross-sectional view illustrating the developing apparatus 130 illustrated in FIG. 1. FIG. 3 is a conceptual view illustrating a first developing roller, a second developing roller and a recovery roller illustrated in FIG. 2. FIG. 4 is a schematic view illustrating a circulatory system screw. FIG. 5 is a cross-sectional view illustrating a developer discharger illustrated in FIG. 4.

As illustrated in FIGS. 2, 4 and 5, the developing apparatus 130 includes a first developing roller 131, a second developing roller 136, a recovery roller 141, a recovery screw 146, circulatory system screws 151 and 156, a developer replenish port 158, a developer discharger 159, a liquid level detection sensor 170, a toner concentration detection sensor 172, and a casing 174. Note that the developing apparatus 130 employs a trickle developing method (also referred to as an auto-refining developing system (AR)). The trickle developing method discharges (discards) a portion of the developer to the outside of the developing apparatus 130 while replenishing a new developer so as to suppress deterioration of the developer.

The first developing roller 131 is a rotatably driven developer carrying body, and is disposed adjacent to the photoconductive drum 122 as illustrated in FIG. 3. The first developing roller 131 includes a sleeve 132 and a fixed magnetic pole and is configured to adsorb (carry) the developer from the circulatory system screws 151 and 156 in accordance with magnetic force.

The sleeve 132 is nonmagnetic and rotatably driven around the rotation shaft 134. The fixed magnetic pole is disposed inside the sleeve 132 and includes sectorial magnetic poles 133A to 133E and a sectorial nonmagnetic pole portion 133F.

The magnetic pole 133A is a north pole, and adsorbs the developer onto the sleeve 132. The magnetic poles 133B, 133C, and 133D are south pole, north pole and south pole, respectively, and convey the adsorbed developer upward as the sleeve 132 rotates. The magnetic pole 133E strips the developer from the sleeve 132 by a repulsive magnetic field generated in cooperation with the magnetic pole 133A. The nonmagnetic pole portion 133F is located between the magnetic pole 133A and the magnetic pole 133E being north poles, and is formed of a nonmagnetic material.

The second developing roller 136 is a second developer carrying body which is driven to rotate and is located on the downstream side of the first developing roller 131 with respect to the rotating direction of the photoconductive drum 122 and is disposed on the upper side of the first developing roller 131. The second developing roller 136 includes a sleeve 137 and a fixed magnetic pole, and is configured to receive the developer from the first developing roller 131 (sleeve 132) in accordance with the magnetic force and adsorb (carry) the developer.

The sleeve 137 is nonmagnetic and rotatably driven around the rotation shaft 139. The fixed magnetic pole is disposed inside the sleeve 137, and includes sectorial magnetic poles 138A to 138E and a sectorial nonmagnetic pole portion 138F.

The magnetic pole 138A is a south pole and allows the developer stripped from the first developing roller 131 (sleeve 132) to be adsorbed (transferred) onto the sleeve 137. The magnetic poles 138B, 138C, and 138D are north pole, south pole and north pole, respectively, and convey the adsorbed developer upward as the sleeve 137 rotates. The magnetic pole 138E is a south pole, and strips the developer remaining without being consumed by the photoconductive drum 122 from the sleeve 137 by the effect of the repulsive magnetic field generated in cooperation with the magnetic pole 138A. The nonmagnetic pole portion 138F is located between the magnetic pole 138A and the magnetic pole 138E being south poles, and is formed of a nonmagnetic material.

The recovery roller 141 is a rotationally driven developer recovery member, and is disposed at an upper portion in a space between the second developing roller 136 and the recovery screw 146. The recovery roller 141 includes a sleeve 142 and a fixed magnetic pole, and is configured to receive the developer from the second developing roller 136 in accordance with magnetic force.

The sleeve 142 is nonmagnetic and rotatably driven around the rotation shaft 144. The fixed magnetic pole is disposed inside the sleeve 142, and includes sectorial magnetic poles 143A to 143E and a sectorial nonmagnetic pole portion 143F.

The magnetic poles 143A and 143B are north pole and south pole, respectively. The magnetic pole 143C is a north pole, and allows the developer stripped from the second developing roller 136 (sleeve 137) to be adsorbed onto the sleeve 142. The magnetic pole 143D is a south pole, and conveys the adsorbed developer downward as the sleeve 142 rotates. The magnetic pole 143E is a north pole, and strips the developer adsorbed by the sleeve 142 from the sleeve 142 by the repulsive magnetic field generated in cooperation with the magnetic pole 143A. The nonmagnetic pole portion 143F is located between the magnetic pole 143A and the magnetic pole 143E being north poles, and is formed of a nonmagnetic material.

Accordingly, after the developer from the circulatory system screws 151 and 156 is adsorbed on the sleeve 132 of the first developing roller 131, the developer is conveyed toward the photoconductive drum 122 by the rotational operation of the sleeve 132, and develops the electrostatic latent image formed on the photoconductive drum 122. Subsequently, after developing the electrostatic latent image formed on the photoconductive drum 122, the developer comes in proximity to the second developing roller 136 by the rotational operation of the sleeve 132, and there the developer is stripped from the sleeve 132 and transferred to the sleeve 137 of the second developing roller 136.

The developer adsorbed on the sleeve 137 is conveyed toward the photoconductive drum 122 by the rotational operation of the sleeve 137, and develops the electrostatic latent image formed on the photoconductive drum 122. Subsequently, after developing the electrostatic latent image formed on the photoconductive drum 122, the developer comes in proximity to the recovery roller 141 by the rotational operation of the sleeve 137, and there the developer is stripped from the sleeve 137 and transferred to the sleeve 142 of the recovery roller 141.

The developer adsorbed on the sleeve 142 is conveyed downward by the rotational operation of the sleeve 142 and is stripped from the sleeve 142 when it comes in proximity to the recovery screw 146 and drops toward the recovery screw 146 by its own weight.

Note that there is a space to permit rotation of the sleeves 132, 137, and 142 arranged between inner circumferences of the sleeves 132, 137, and 142 and outer circumferences of the fixed magnetic poles 133A to 133F, 138A to 138F, and 143A to 143F. In addition, the nonmagnetic pole portions 133F, 138F, and 143F can also be constituted by a space.

The recovery screw 146 is located below the recovery roller 141, and conveys the developer transferred (recovered) from the recovery roller 141 while stirring the developer. Note that reference numeral 178A denotes a portion (developer reservoir) where the recovered developer is temporarily reserved.

The circulatory system screws 151 and 156 are rotationally driven developer stirring members, and are located below the first developing roller 131 and the recovery screw 146. In the present embodiment, the circulatory system screws 151 and 156 are constituted by a supply screw 151 and a stirring screw 156. In the following, the circulatory system screws 151 and 156 will be appropriately referred to as the supply screw 151 and the stirring screw 156.

The supply screw 151 is located between the first developing roller 131 and the stirring screw 156. There is provided a partition wall 175 of the casing 174, between the supply screw 151 and the stirring screw 156.

Note that there is provided a communication port (not illustrated) in the partition wall of the casing 174 located between the supply screw 151 and the recovery screw 146. Accordingly, the developer stirred by the recovery screw 146 drops due to its own weight toward the supply screw 151 via the communication port (introduced into the supply screw 151) (refer to FIG. 2).

Conveyance directions of the feeding screw 151 and the stirring screw 156 are opposite to each other. A leading end side and a trailing end side of a conveyance path 152 of the supply screw 151 are individually linked (communicate) with a trailing end side and a leading end side of a conveyance path 157 of the stirring screw 156, respectively, via communication ports 176A and 176B respectively provided in the partition wall 175. Accordingly, the developer circulates in the clockwise and in the substantially horizontal direction indicated by arrows in FIG. 4, and a part of the circulating developer flows out (to be supplied) toward the first developing roller 131 (refer to FIG. 4). Note that reference numerals 178B and 178C denote portions (developer reservoirs) that reserve the developer relevant to the supply screw 151 and the stirring screw 156, respectively.

The developer replenish port 158 and the developer discharger 159 are provided to implement the trickle development method.

The developer replenish port 158 is disposed in the casing 174 above the stirring screw 156 (refer to FIG. 2) and is linked to the developer reservoir 196 (refer to FIG. 1). The developer replenish port 158 can replenish the developer stored in a bottle prepared on the developer reservoir 196 to the developer reservoir 178C relevant to the stirring screw 156. As described above, the toner weight ratio of the developer reserved in the bottle of the developer reservoir 196 is larger than the toner weight ratio of the developer in the developing apparatus 130. Accordingly, adjusting the developer replenished to the developer reservoir 178C enables maintaining the toner weight ratio of the developer in the developing apparatus 130 to be a constant level.

The developer discharger 159 is disposed on the trailing end side of the conveyance path 157 of the stirring screw 156 (located on the extension of the developer in the conveyance direction) (refer to FIGS. 4 and 5). The developer discharger 159 includes a reverse screw portion 159A, an outgoing path 159B and a developer discharge port 159C. The reverse screw portion 159A holds back the developer that has been conveyed (circulated) through the conveyance path 157. The outgoing path 159B is defined by a space between the reverse screw portion 159A and the casing 174 located above the reverse screw portion 159A, and communicates to the developer discharge port 159C.

Accordingly, when the liquid level of the developer in the developer reservoir 178C relevant to the stirring screw 156 is located above the reverse screw portion 159A, the developer would be discharged to the outside through the outgoing path 159B and the developer discharge port 159C. At this time, the discharge amount of the developer corresponds to the driving speed of the stirring screw 156. Accordingly, the discharge amount of the developer by the developer discharger 159 can be adjusted by changing the driving speed of the stirring screw 156. In other words, the controller 105 can adjust the discharge of the developer by changing the driving speed of the stirring screw 156. Note that the developer discharger 159 is not limited to the above configuration.

The liquid level detection sensor 170 (refer to FIG. 2) is disposed to detect the developer liquid level (rising level) in the developer reservoirs 178B and 178C relevant to the circulatory system screws 151 and 156. The liquid level of the developer is used to maintain the circulation amount of the developer at an appropriate level.

The toner concentration detection sensor 172 (refer to FIG. 2) is provided to detect the toner concentration contained in the developer reservoirs 178B and 178C relevant to the circulatory system screws 151 and 156. The toner concentration is used to control the replenishment of the developer from the developer reservoir 196 so as to correspond to the toner consumption amount in the developing apparatus 130. For example, when the toner concentration is detected to be below a predetermined value, the developer is replenished from the developer reservoir 196. Since the magnetic permeability of the developer varies with the toner concentration, it is possible to detect the toner concentration by using the magnetic permeability.

Next, control of the first developing roller, the second developing roller, the recovery roller, the recovery screw, the supply screw, and the stirring screw will be described.

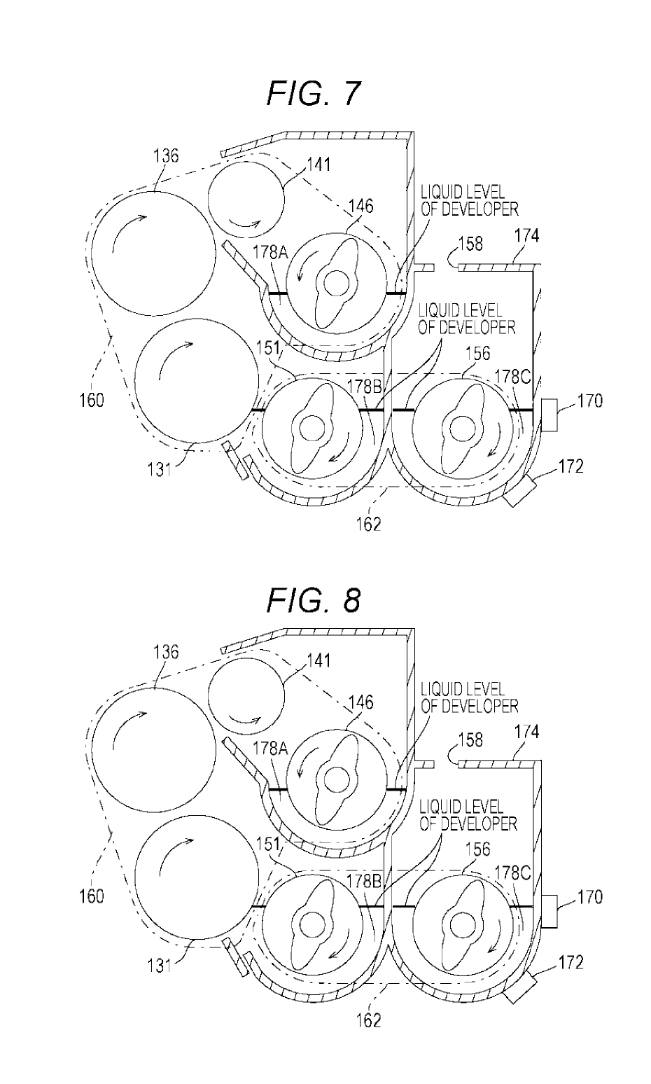

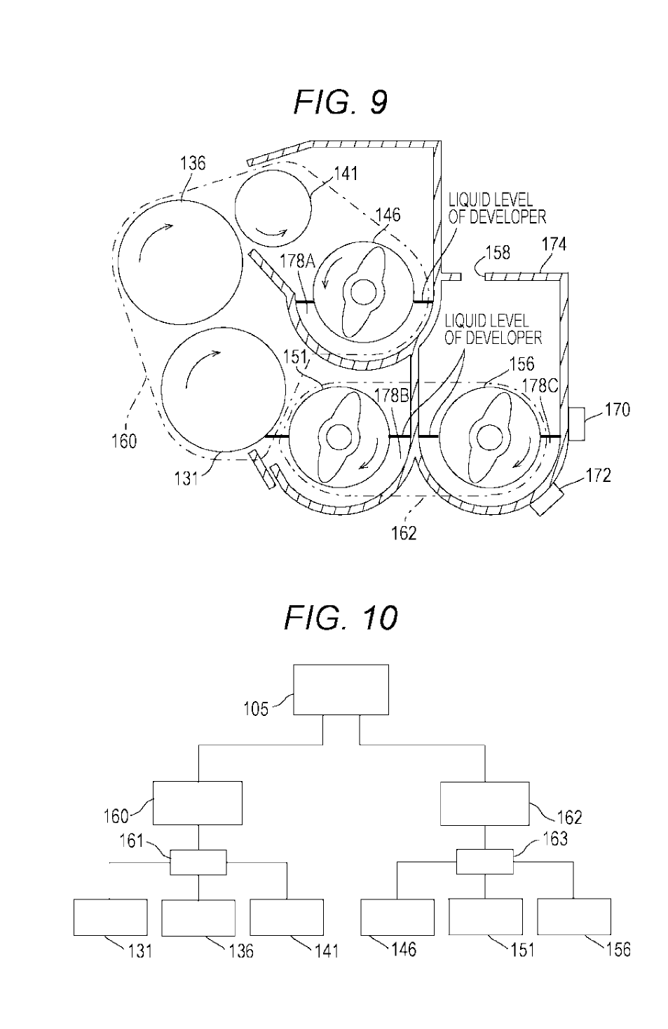

FIG. 6 is a block diagram illustrating a first motor for driving the first developing roller, the second developing roller, the recovery roller, and the recovery screw, and a second motor for driving the circulatory system screw. FIG. 7 is a cross-sectional view illustrating the liquid level of the developer in a standard state. FIG. 8 is a cross-sectional view illustrating the liquid level of the developer when the driving speeds of the first and second developing rollers are increased. FIG. 9 is a sectional view illustrating the liquid level of the developer in a case where discharge of the developer is excessive.

As illustrated in FIG. 6, the developing apparatus 130 further includes a first motor 160, a transmission device 161, a second motor 162, and a transmission device 163.

The first motor 160 is controllable by the controller 105 and is a driving source configured to drive the first developing roller 131, the second developing roller 136, the recovery roller 141 and the recovery screw 146 at the same speed via the transmission device 161. The second motor 162 is controllable by the controller 105, and is a driving source configured to drive the circulatory system screw (the supply screw 151 and the stirring screw 156) at a same speed via the transmission device 163.

In other words, the driving speeds of the first developing roller 131, the second developing roller 136, the recovery roller 141, and the recovery screw 146 can be independently controlled from the driving speeds of the circulatory system screws 151 and 156. Note that the driving speeds of the supply screw 151 and the stirring screw 156 constituting the circulatory system screws 151 and 156 are preferably constant in order to maintain the circulation balance of the developer.

It is preferable to set the driving speed of the recovery screw 146 at the design stage so as to satisfy the expression (RA≥CA), where RA is the developer amount (g/s) returned to the circulatory system screws 151 and 156 by the recovery screw 146, CA is the developer amount (g/s) conveyed to the recovery screw 146 by the first developing roller 131 and the second developing roller 136.

It is preferable that the driving speeds of the circulatory system screws 151 and 156 are to be appropriately controlled on the basis of the liquid level of the developer conveyed by the circulatory system screws 151 and 156 (liquid level of the developer reservoirs 178B and 178C detected by the liquid level detection sensor 170).

For example, the amount of developer from the first developing roller 131 and the second developing roller 136 increases in a case where the driving speeds of the first developing roller 131 and the second developing roller 136 increase in comparison with the standard state illustrated in FIG. 7 in accordance with the content of the print job (types of sheets and image forming speed to be applied). However, the speed relationship between the driving speed of the recovery screw 146 and the driving speed of the first developing roller 131 and the second developing roller 136 would not change, and thus, the amount of the developer returned from the recovery screw 146 to the circulatory system screws 151 and 156 increases, making it possible to suppress excessive stagnation of the developer in the developer reservoir 178A.

This makes it possible to maintain the liquid level of the developer in the developer reservoirs 178B and 178C relevant to the circulatory system screws 151 and 156 to a constant level with no reduction. That is, even in a case where the driving speeds of the first developing roller 131 and the second developing roller 136 increase, the developer liquid level of the developer reservoirs 178A, 178B and 178C can be maintained to a constant level as illustrated in FIG. 8.

Furthermore, in a case, for example, where physical properties of the developer have changed due to high-temperature and high-humidity atmosphere environment and this has caused excessive discharge of the developer, the developer liquid level of the developer reservoirs 178B and 178C relevant to the circulatory system screws 151 and 156 would be reduced.

The discharge of the developer can be adjusted by changing the driving speeds of the circulatory system screws 151 and 156. Therefore, in order to return the developer liquid levels of the developer reservoirs 178B and 178C to the standard states, the driving speed of the circulatory system screw is controlled to be reduced so as to suppress the discharge of the developer.

At this time, the driving speeds of the first developing roller 131, the second developing roller 136, the recovery roller 141, and the recovery screw 146 can be independently controlled. Therefore, even when the driving speed of the circulatory system screw decreases, it would be still possible to maintain the driving speeds of the first developing roller 131 and the second developing roller 136 and the driving speed of the recovery screw 146 to a constant level (with no change in the speed relationship). This can suppress excessive stagnation of the developer in the developer reservoir 178A relevant to the recovery screw 146 (the developer liquid level does not rise and the standard state is maintained) Accordingly, it is possible maintain the developer liquid level of the developer reservoirs 178A, 178B and 178C to a constant level as illustrated in FIG. 9.

Note that in another case where the discharge amount of the developer is insufficient and the liquid level of the developer is high, it is possible to increase the driving speed of the circulatory system screws 151 and 156 to increase the discharge amount of the developer, thereby achieving reduction of the liquid level of the developer.

Next, a comparative example will be described.

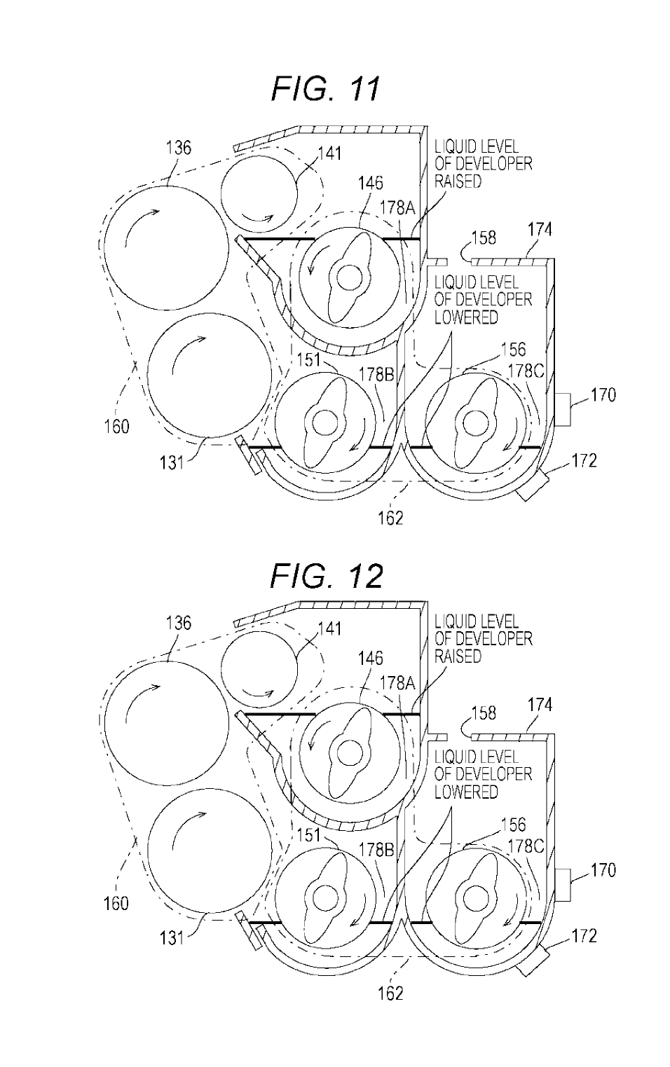

FIG. 10 is a cross-sectional view illustrating a developing apparatus according to a comparative example. FIG. 11 is a sectional view illustrating a developer liquid level in a case where the driving speeds of the first and second developing rollers are increased in the comparative.

In the comparative example, as illustrated in FIG. 10, the first motor 160 is a driving source configured to drive the first developing roller 131, the second developing roller 136, and the recovery roller 141 at a same speed via the transmission device 161. The second motor 162 is a driving source configured to drive the recovery screw 146 and the circulatory system screws 151 and 156 at a same speed via the transmission device 163.

According to this configuration, for example, in a case where the driving speeds of the first developing roller 131 and the second developing roller 136 increase from the standard state, the amount of the developer returned from the first developing roller 131 and the second developing roller 136 to the recovery screw 146 would increase. Meanwhile, the recovery screw 146 is driven at the same speed as the circulatory system screws 151 and 156, the amount of the developer returned from the recovery screw 146 to the circulatory system screws 151 and 156 would be constant (would not change). This would cause, as illustrated in FIG. 11, the developer to excessively stagnate in the developer reservoir 178A relevant to the recovery screw 146 (the developer liquid level would rise). Excessive stagnation of the developer in the developer reservoir 178A would cause breakage of a developing device due to an increase in pressure of the developer.

Furthermore, the amount of the developer returned from the developer reservoir 178A would decrease, leading to reduction of the developer liquid level in the developer reservoirs 178B and 178C relevant to the circulatory system screws 151 and 156. The reduction of the liquid level of the developer would cause erroneous detection by the toner concentration detection sensor 172 and cause reduction of the amount of developer supplied to the first developing roller 131 and the second developing roller 136. For example, accuracy of the toner concentration detection sensor 172 is affected by the liquid level of the developer, and thus, the decrease in the liquid level would cause erroneous detection, leading to inappropriate replenishment amount (replenishment timing) of the developer from the developer reservoir 196. Moreover, the decrease in the amount of the developer (insufficient supply of the developer) would cause nonuniform development on the photoconductive drum 122, and this would cause uneven image density.

FIG. 12 is a cross-sectional view illustrating a developer liquid level in a case where the developer discharge is excessive in the comparative example.

In the comparative example, in a case where the discharge of the developer is excessive, the driving speed of the circulatory system screws 151 and 156 might be lowered in order to return the liquid level of the liquid developer in the developer reservoirs 178B and 178C to the standard state. This would suppress the discharge of the developer and cause a decrease in the driving speed of the recovery screw 146, which is driven in the same manner.

This would reduce the amount of developer returned from the recovery screw 146 to the circulatory system screws 151 and 156. On the other hand, the amounts of developer from the first developing roller 131 and the second developing roller 136 would not change. This would naturally cause excessive stagnation of the developer in the developer reservoir portion 178A relevant to the recovery screw 146 (developer liquid level rises) as illustrated in FIG. 12.

Furthermore, the amount of the developer returned from the developer reservoir 178A decreases, and this would result in maintaining the developer liquid level in the developer reservoirs 178B and 178C relevant to the circulatory system screws 151 and 156 at a level that would not rise (low level is maintained) This would cause erroneous detection by the toner concentration detection sensor 172 and reduction of the amount of developer supplied to the first developing roller 131 and the second developing roller 136.

As described above, according to the present embodiment, it is possible to suppress stagnation of the developer in the developer reservoir 178A relevant to the recovery screw 146 and suppress the fluctuation in the developer liquid level of the developer reservoirs 178B and 178C relevant to the circulatory system screws 151 and 156.

Note that the driving speeds of the circulatory system screws 151 and 156 can be appropriately controlled on the basis of the durability state of the developer. The durability state of the developer is estimated on the basis of the use amount of the developer, the use time of the developer, and the number of sheets to which the developer is applied, for example. Specifically, in a case where the charge amount of the developer is reduced due to the long use time of the developer, this might cause reduction of the liquid level of the developer in the developer reservoir, leading to erroneous detection of the toner concentration sensor and defective conveyance of the developer. To avoid this, the driving speeds of the circulatory system screws 151 and 156 will be controlled to raise the liquid level of the developer in the developer reservoir (to be maintained at an appropriate level).

The driving speed of the circulatory system screws 151 and 156 can be appropriately controlled on the basis of the charge amount of the toner contained in the developer. For example, since the liquid level of the developer changes depending on the charge amount of the toner, it would be possible to use the charge amount of the toner instead of the liquid level of the developer. Note that the charge amount of the toner is measured by using an ammeter connected to the developing roller and an optical sensor for detecting the toner adhesion amount on the photoconductive drum, for example. More specifically, the toner charge amount is measured by first forming a plurality of patch images having different amounts of adhesion on the photoconductive drum, and then a change amount in current occurring in the path between the developing roller and the photoconductive drum and a change amount in the adhesion amount of the image transferred to the sheet are detected corresponding to the plurality of patch images. Subsequently, the charge amount of the toner is obtained from the ratio of the change amount of the current to the change amount of the adhesion amount. The method of measuring the charge amount of toner is not limited to this configuration.

The driving speeds of the circulatory system screws 151 and 156 can also be appropriately controlled on the basis of the durability state of the surfaces of the first developing roller 131 and the second developing roller 136. For example, in a case where the surface of the sleeve of the first developing roller 131 and the second developing roller 136 wears out and this causes reduction of the conveyance amount of the developer, the driving speed of the circulatory system screws 151 and 156 can be controlled to increase the conveyance amount of the developer. Note that the durability state of the first developing roller 131 and the second developing roller 136 can be estimated on the basis of the use amount of the developer applied to the first developing roller 131 and the second developing roller 136, the number of sheets relevant to this operation, or the like.

The driving speed of the circulatory system screws 151 and 156 can be appropriately controlled on the basis of the printing area ratio (coverage) being an area ratio of a portion where the toner adheres to a region where the image formed of the toner is formed. For example, in a case where high coverage continues, or where high coverage and low coverage are frequently switched, this indicates that degradation of the developer is promoted and the physical properties of the developer (the liquid level in the developer reservoir) are changed.

Next, first and second modifications according to the embodiment of the present invention will be sequentially described.

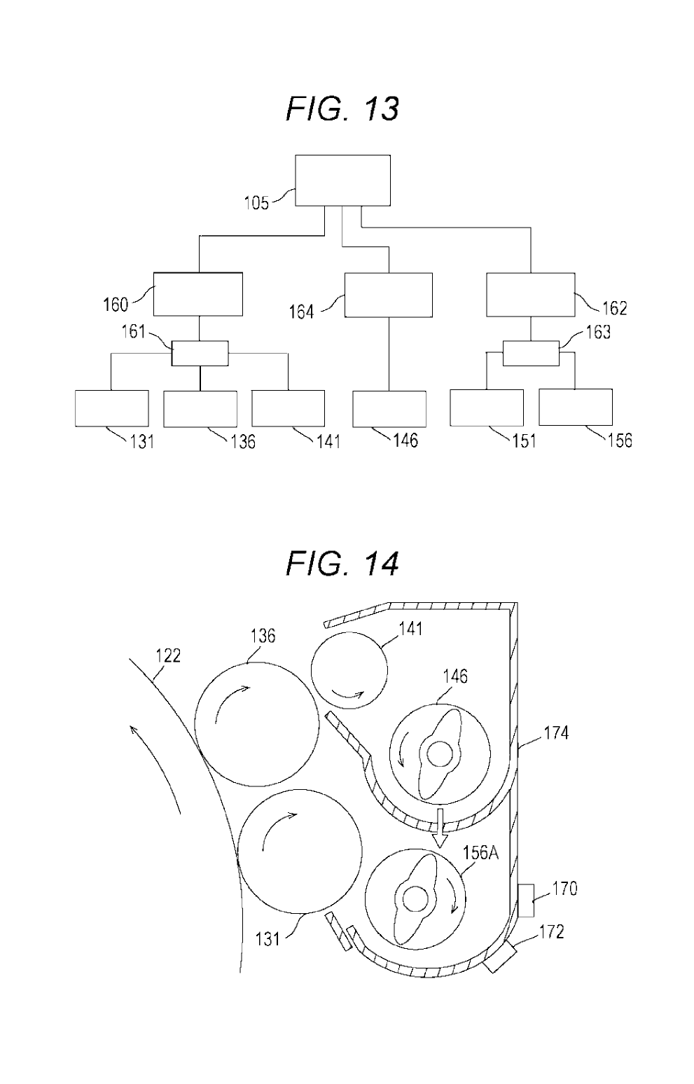

FIG. 13 is a schematic diagram illustrating the first modification according to the embodiment of the present invention.

The motor for driving the recovery screw 146 is not limited to the configuration of using the same (common) motor for driving the first developing roller 131 and the second developing roller 136. For example, as illustrated in FIG. 12, it is also possible to provide a motor (a third motor 164) dedicated (to be independently driven) for the recovery screw 146. In this case, it is possible to independently control the recovery screw 146, leading to enhanced degree of freedom in the control of the recovery screw 146.

FIG. 14 is a schematic view illustrating a second modification according to the embodiment of the present invention.

The circulatory system screw is not limited to a configuration including the supply screw 151 and the stirring screw 156. For example, as illustrated in FIG. 14, it is possible to configure that circulatory system screw by a single screw 156A having functions of both the supply screw 151 and the stirring screw 156.

As described above, according to the present embodiment, the driving speed of the developer stirring member (circulatory system screw) and the driving speed of the developer recovery member (recovery screw) can be controlled independently. This makes it possible to maintain a constant speed relationship between the developer carrying body (developing roller) and the developer recovery member even in a case where there is a change in the speed relationship between the developer carrying body and the developer stirring member. Accordingly, it is possible to suppress stagnation of the developer in the developer reservoir relevant to the developer recovery member and suppress fluctuation of the developer liquid level of the developer reservoir relevant to the developer stirring member. That is, it is possible to provide a developing apparatus and an image forming apparatus capable of suppressing stagnation of a developer in the developer reservoir relevant to a developer recovery member and suppress fluctuation of the liquid level of the developer in the developer reservoir relevant to a developer stirring member even when there is a change in a speed relationship between the developer carrying body and the developer stirring member.

The present invention is not limited to the above-described embodiments, and various modifications can be made within the scope of the claims For example, the image forming apparatus is not limited to the MFP, and can be implemented by application of a printer dedicated to printing or a facsimile apparatus. Furthermore, the shapes of the blade of the recovery screw, the supply screw, and the stirring screw are not particularly limited, and for example, it is possible to apply a spiral blade or a paddle-like blade.

Independent control of the driving speed of the developer stirring member (circulatory system screw) and the driving speed of the developer recovery member (recovery screw) is not limited to an embodiment achieved by a plurality of driving sources (motors). For example, it is possible to use a clutch, a multistage gear or the like to achieve independent control by a single driving source. The number of developing rollers may be one, or three or more. The circulatory system screw can be constituted by three or more screws. It is also possible to substitute the recovery roller by a guide member (slope), or it is possible to further add a guide member (slope) adjacent to the recovery roller.

Although embodiments of the present invention have been described and illustrated in detail, the disclosed embodiments are made for purposes of illustration and example only and not limitation. The scope of the present invention should be interpreted by terms of the appended claims

What is claimed is:

1. A developing apparatus comprising:
a developer carrying body that carries a developer and is rotationally driven;
a developer stirring member that is rotationally driven and thereby stirs the developer and conveys the developer to the developer carrying body; and
a developer recovery member that is rotationally driven and thereby returns and recovers the developer stripped from the developer carrying body after development of the electrostatic latent image, to the developer stirring member,
wherein a driving speed of the developer stirring member and a driving speed of the developer recovery member are independently controllable from each other.

2. The developing apparatus according to claim 1, wherein the driving speed of the developer stirring member, the driving speed of the developer recovery member, and a driving speed of the developer carrying body are independently controllable from each other.

3. The developing apparatus according to claim 1, wherein the driving speed of the developer recovery member is set to satisfy the following expression:
RA≥CA,
where
RA: developer amount (g/s) to be returned to the developer stirring member by the developer recovery member, and
CA: developer amount (g/s) to be conveyed to the developer recovery member by the developer carrying body.

4. The developing apparatus according to claim 1, further comprising
a developer discharger that discharges the developer to an outside of the developing apparatus,
wherein the developer discharger is located in an extending direction of a developer conveyance direction directed by the developer stirring member, and
a discharge amount of the developer by the developer discharger is adjustable by changing the driving speed of the developer stirring member.

5. An image forming apparatus comprising:
the developing apparatus according to claim 1;
an image carrying body on which the electrostatic latent image is formed; and
a hardware processor that controls the developing apparatus,
wherein the hardware processor controls to transfer toner contained in a developer carried by the developer carrying body to the image carrying body and develop the electrostatic latent image to form an image formed of the toner.

6. The image forming apparatus according to claim 5, wherein the hardware processor controls a driving speed of the developer stirring member on the basis of a liquid level of the developer conveyed by the developer stirring member.

7. The image forming apparatus according to claim 5, wherein the hardware processor controls a driving speed of the developer stirring member on the basis of a durability state of the developer.

8. The image forming apparatus according to claim 5, wherein the hardware processor controls a driving speed of the developer stirring member on the basis of a charge amount of the toner contained in the developer.

9. The image forming apparatus according to claim 5, wherein the hardware processor controls a driving speed of the developer stirring member on the basis of a durability state of the developer carrying body.

10. The image forming apparatus according to claim 5, wherein the hardware processor controls a driving speed of the developer stirring member on the basis of a printing area ratio being an area ratio of a portion where the toner adheres to a region where the image formed of the toner is formed.
